(19) United States
(12) Patent Application Publication
(10) Pub. No.: US 2010/0140330 A1
(43) Pub. Date: Jun. 10, 2010

(54) Conductive Coatings, Sealing Materials and Devices Utilizing Such Materials and Method of Making

(76) Inventors: Dilip Kumar Chatterjee, Big Flats, NY (US); Thomas Dale Ketcham, Big Flats, NY (US); Dell Joseph St. Julien, Watkins Glen, NY (US)

Correspondence Address: CORNING INCORPORATED, SP-TI-3-1, CORNING, NY, 14831, US

(21) Appl. No.: 12/529,631

(22) PCT Filed: Mar. 5, 2008
(86) PCT No.: PCT/US08/02909

§ 371 Date: Jan. 5, 2010

Related U.S. Application Data
(60) Provisional application No. 60/905,642, filed on Mar. 8, 2007.

(51) Int. Cl. B23K 31/02; B23K 1/00; B23K 35/22

(52) U.S. Cl. 228/122.1; 148/26

(57) ABSTRACT

According to one embodiment t of the present invention a method of manufacturing metal-to-ceramic seals comprising the steps of: (a) providing a ferric stainless steel part selected from the group consisting of high temperature stainless steels and high temperature superalloy; (b) providing a ceramic part; (c) providing a braze material in between the ferric stainless steel part and said ceramic part, the braze containing Ag and metal oxide wetting agents; and (d) heating said ferric stainless steel part, braze material, and ceramic part in an oxidizing atmosphere.

### BACKGROUND OF THE INVENTION

1. Field of the Invention

The present invention relates generally to brazing alloys suitable for use, for example, in solid oxide fuel cells (SOFC).

2. Technical Background

To function properly, many high temperature electrochemical devices, such as ceramic-based fuel cells, oxygen generators, and chemical sensors, often require metal and ceramic components to be hermetically sealed each other. Unfortunately, the chemical and physical characteristics of many of the ceramic and metal components used in these devices have presented a variety of challenges for the development of effective seals. For example, one standard electrolyte material currently employed in nearly all of these devices is yttria stabilized zirconia (YSZ) because of its excellent oxygen ion transport properties, insulating electronic nature, and exceptional chemical stability under a wide variety of operating conditions and environments. However, to generate a sufficiently high rate of ionic trans-port, the device must be operated at high temperature, typically on the order of 650-900° C., and the thickness of the electrolyte membrane must be minimized; though generally no thinner than 5-10 μm, to mitigate the formation of through-thickness pinhole defects during manufacture. Since a solid state electrochemical device such as a fuel cell functions due to the oxygen ion gradient that develops across the electrolyte membrane, not only is hermiticity across the membrane important, but also that across the seal which joins the electrolyte to the body of the device. That is, the YSZ layer must be dense, must not contain interconnected porosity, and must be connected to the rest of the device with a high temperature, gas-tight seal. Typical conditions under which these devices are expected to operate and to which the accompanying YSZ-to-metal joints will be exposed include: 1) an average operating temperature of 750° C.; 2) continuous exposure to an oxidizing atmosphere on the cathode side; and 3) an anticipated device lifetime of 3000-30,000+ hours, as defined by the specific application. Depending on the function of the device, e.g. energy generation, the seal may also be exposed to a reducing environment on the anode side.

One approach is bonding YSZ membrane to alumina forming metal while utilizing a braze that contains non-reactive (non oxidizing) material and braze temperature modifying agents. The braze temperature modifying agents are selected from braze temperature raising agents selected from the group consisting of Pd. Pt, and combinations thereof, and braze temperature lowering agents selected from the group consisting of V₂O₅, MoO₃, and combinations thereof. However, the liquid metal does not readily wet the ceramic surface. This results in discontinuous joints that are not hermetic (as shown in attached figures). In fuel cell environments this type of joints/seals are unacceptable because of intermixing of fuel (hydrogen) with air.

Therefore, the first challenge in metal-to-ceramic joining, specifically for fuel cell applications is to alter the interfacial thermodynamics to render the ceramic surface wettable. Thus, there exists a need for new methods of forming seals that overcome these difficulties and produce metal to ceramic seals which function satisfactorily in these demanding environments. Thus the need to have alternative frit compounds for solid oxide fuel cells has been the subject of considerable amount of research in recent years.

### SUMMARY OF THE INVENTION

One advantage of the sealing material of the present invention is that it seals fuel cell device components at temperature ranges (700-900° C.) while having CTEs that are compatible with the CTEs of these components. Another advantage of the sealing material of the present invention is that the resultant seals are durable in the SOFC environments.

According to one embodiment of the present invention a method of manufacturing metal-to-ceramic seals comprising the steps of: (a) providing a ferric stainless steel part selected from the group consisting of high temperature stainless steels and high temperature superalloy; (b) providing a ceramic part; (c) providing a braze material in between the ferric stainless steel part and said ceramic part, the braze containing Ag and metal oxide wetting agents; and (d) heating said ferric stainless steel part, braze material, and ceramic part in an oxidizing atmosphere. According to some embodiment the metal oxide wetting agents are selected from the group consisting of: CuO; PbO; Nb₂O₃; PdO₂; MoO₃. According to some embodiments the ferric stainless are non alumina forming steels preferably selected from the group consisting of AISI 430, 441, 446, E-Brite, Powder Metallurgically prepared ITM.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description present exemplary embodiments of the invention, and are intended to provide an overview or framework for understanding the nature and character of the invention as it is claimed. The accompanying drawings are included to provide a further understanding of the invention, and are incorporated in and constitute a part of this specification. The drawings illustrate various embodiments of the invention and together with the description serve to explain the principles and operations of the invention.

### DETAILED DESCRIPTION OF PREFERRED EMBODIMENT

Wetting and adhesion are important considerations to have effective application of conductive metal layers and/or brazing layers. Wetting is essential in creating leak-tight joints in brazing. In a properly designed joint, the molten filler metal is normally drawn completely through the joint area without any voids or gaps, and brazed joints remain liquid- and gas-tight under heavy pressures, even when the joint is subjected to shock or vibrational types of loading. Capillary action results in the phenomenon where surface tension causes molten braze filler metal to be drawn into the area that covers the parallel surfaces that are to be brazed. Capillarity action is a result of surface tension between base metals(s), filler metal, flux, or atmosphere and the contact angle between ferritic stainless steel and the braze or conductive metal layer. In actual practice, braze flow characteristics are also influenced by dynamic considerations involving viscosity, vapor pressure, gravity, and metallurgical reactions between filler metal and base metal.

Many electro-chemical devices require hermetic seals. Solid oxide fuel cell (SOFC) device is one of such devices and the seal between the ceramic electrolyte sheet (also referred to herein as an electrolyte membrane) and the attached metal frame needs to be hermetic. It is preferred that the electrolyte sheet(s) in SOFC systems contain various amounts of rare earth stabilized zirconia (one example is Yttria stabilized zirconia, YSZ) and that the frame materials are chosen from high temperature ferritic (non alumina forming) stainless steels. It is preferable that such steels contain more than 23 mole % Cr. High Cr steel has better oxidation resistance and the kinetics of Cr oxide scale formation are significantly reduced providing a more stable scale and therefore a more adherent contact to the braze. In contrast, alloys with 16% Cr, such as 430 stainless steel, form thick chrome oxide layers that are relatively poorly adhered to the base stainless steel component. This may result in significantly weakened seal strength when a braze is employed to seal a ceramic component to the stainless steel component.

Preferably, air brazing of ceramic electrolyte sheets to metals is utilized. Although brazing to alumina forming metals is known, when metallic materials are utilized (when no alumina former is present) previous method did not generally produce hermetically sealed brazed joints. These joints were not hermetic enough, primarily because of incomplete and nonuniform adhesion to the mating surfaces. We also discovered that difficulties in air brazing of ferritic stainless steels were caused by the partial adhesion or partial wetting of the ceramic and metal surfaces to be brazed.

According to the embodiments of invention, a family of improved conductive layer or brazing material is capable of producing hermetic seals for SOFC devices which function satisfactorily in SOFC's demanding environments. According to some embodiments, a method of manufacturing the hermatic seal includes the step of ‘air brazing’ (can also be applicable for atmospheric controlled brazing) of ceramic components, more specifically zirconia ceramics, and more specifically thin membranes of 3 mole % Yttria stabilized zirconia with inorganic metal or alloys, more specifically ferritic stainless steels, for example, AISI 430, 441, 446, E-Brite, P/M ITM and others high Cr steels. According to the embodiments of the present invention, brazing was done primarily using Ag—CuO. Cu₂O peritectic and Ag—CuO eutectic as braze materials, preferably with excess copper oxide in the braze filler. One exemplary braze or conductive layer composition is 95 to 98 mole % Ag, and balance (2 to 5 mole %) is CuO, and preferred brazing condition is in ambient air at temperatures in the range of 900° C. to 950° C. Brazing conditions above 950° C. produce enhance growth of the chrome oxide scale and subsequently lower adhesive strength between the stainless steel part and the electrically conductive layer or braze seal.

Silver-copper oxide eutectic filler material can be produced by melting the ingredients. For example, silver and copper, in the composition range described above are produced by melting and then internal oxidation is performed. Alternatively silver and CuO are melted together and excess copper oxide added to promote good wetting characteristics. After melting the ingots need to be homogenized and rolled to form thin ribbons. Rolled thin ribbons/foils of this filler material can be placed in between the mating surfaces of ceramics and metal components and to heated in air in the temperature range of 850° C. to 1200° C. (e.g., 900° C. to 950° C.) for an hour in air at a rate of 5° C. to 10° C./min and cooled to room temperature at a rate of 2° C./min to 5° C./min to get hermetic seals of the components. Alternately, powders can be formed from the alloys, formed into pastes using appropriate organic solvents and additives, screen printed onto the electrolyte sheet, and heated at 750° C. to 1300° C. to form conductive layers.

Alternatively, the silver-copper oxide braze filler can be produced with screen printing of copper oxide paste onto silver paste (or silver foils). For good wetting and efficient capillary actions of the filler, the silver was screen printed first on the metal and ceramic surfaces, and then copper oxide was screen printed on silver and bonded together and clamped before heating.

It was observed that excess copper oxide enhanced the wettability of the filler materials. It was also observed that various oxides such as PbO, V₂O₅, Nb₂O₃, PdO₂, and MoO₃ promote wetting and capillary characteristics of the fillers in greatly contributing towards hermetic sealing of the ceramic-metal systems. Applicants discovered that are preferred because they promote wetting between non-alumina forming metal components and brazing materials.

Alloys suitable for conductive coatings and sealing materials for application in solid electrolyte fuel cells include the above Ag—CuO alloys. A further improvement is to use alloys of Ag containing an adhesive component selected from: Pd, Cu, Sn, or group IVB, V, VIB, VIIB transition metals (specifically Ti, Zr, Hf, V, Nb, Ta, Cr, Mo, W, Mn. These metal additives promote adhesion to the ceramic layer and can be used to form alloys with silver for both powder application as well as metal foil application. Alloys with Ag may be formed using melts or by mixing of metal powders and alloying them during heating. Application of these alloys is preferably performed in an environment with reduced oxygen content. Proper choice of oxygen partial pressure (pO₂) enables the additive to wet the electrolyte surface while retarding the kinetics of scale formation on the metal. In this way, high Cr ferritic steels can be employed without excessive scale formation.

In case of anode-side conductive layers (fuel facing SOFC side), additional elements can be advantageous. These elements can include rare earths and alkaline earths. These elements will form adhesive metal oxide contacts with the electrolyte sheet even at very low pO2. These elements are known to form low melting eutectics with Ag such as Ag-10Sm with a melting point of 760° C. On contact with the oxygen rich electrolyte, Ag-10Sm alloy will yield a Sm₂O₃ contact or bonding layer while simultaneously raising the melting point of the remaining Ag—Sm alloy. The oxide bonding layer so formed will be resistant to reduction in use. In contrast, Ag—Cu and Ag—Pd alloys are reduced to metal when exposed to the anode-side fuel environment and the resulting bond with the electrolyte is greatly diminished.

The disclosed alloys and mixtures of the embodiments of the present invention are advantageous for use in conductive layers in the fuel stream. These components include metal contacts, via pads, via fill, bus bars and other conductive elements, as well as contacts to current leads.

In the case of sealing, a disadvantage of the Ag—CuO alloy by itself is that the CuO will reduce on exposure to fuel reducing the strength of the seal. This is true of noble metal additives in general. The addition of the alloying elements of this invention provides an oxidized component that remains so even under these reducing fuel-side conditions. The group IVB, V, VIB, VIIB transition metal oxides, for example V₂O₃, Ta₂O₃, MnO, TiO₂, and Cr₂O₃, are stable under fuel-side conditions (typically pO₂<10⁻¹¹ and often pO₂<10⁻¹⁴) at 700 C to 800 C. In addition, alkaline earths and rare earth oxides are stable under these conditions. For example, once Sm2O3 is formed it will not reduce to Sm metal even at much lower oxygen partial pressures. The alloys may be first formed from the melt and then formed into powders that are applied in layers of 1 to 100 microns and sintered.

Ag alloys may be formed of single metal pairs or containing multiple alloying elements. For example an alloy of Ag, Pd and Ta may be formed for this use.

It will be apparent to those skilled in the art that various modifications and variations can be made to the present invention without departing from the spirit and scope of the invention. Thus, it is intended that the present invention covers the modifications and variations of this invention provided they come within the scope of the appended claims and their equivalents.

What is claimed is:

1. A method of manufacturing metal-to-ceramic seals comprising the steps of:
a) providing a ferric non alumina forming stainless steel part selected from the group consisting of high temperature stainless steels and high temperature superalloys, said stainless steel part has greater than 23 mole % Cr,
b) providing a ceramic part;
c) providing a braze material in between said ferric non alumina forming stainless steel part and said ceramic part, said braze containing Ag and metal oxide wetting agents,
d) heating said ferric non alumina forming stainless steel part forming part, braze material, and ceramic part in an oxidizing atmosphere.

2. The method of claim 1, wherein said metal oxide wetting agents are selected from the group consisting of: CuO; PbO; Nb₂O₃; PdO; MoO₃.

3. The method of claim 1, wherein said high temperature ferric stainless are selected from the group consisting of AISI 430, 441, 446, E-Brite, Powder Metallurgically prepared ITM.

4. The method of claim 1 wherein said braze material is between 30.65 to 100 mole % Ag in CuO.

5. The method of claim 1, wherein the step of heating said alumina forming metal part, braze material, and ceramic part in an oxidizing atmosphere is performed in air at a temperature of between 800° C. and 1300° C.

6. An alloy comprising: a Ag containing alloy or mixture; and an adhesive component selected from: Pd, Cu, Sn, or group IVB, V, VIB, VIIB transition metals.

7. The alloy according to claim 6 comprising at least one element selected from: Ti, Zr, Hf, V, Nb, Ta, Cr, Mo, W, Mn.

8. An alloy comprising: a Ag containing alloy or mixture; and an adhesive component selected from: Sn, or group IVB, V, VIB, VIIB transition metals.

9. The alloy according to claim 8 comprising at least one element selected from: Ti, Zr, Hf, V, Nb, Ta, Cr, Mo, W, Mn.

10. The alloy of claim 6 formed as metal powder.

11. The alloy of claim 6, produced by mixtures of metal powders that are fired in-situ.
